(19) United States
(12) Patent Application Publication
(10) Pub. No.: US 2010/0065206 A1
(43) Pub. Date: Mar. 18, 2010

(54) Blanket-Like Laminate for Insulating Surfaces

(75) Inventor: Gary E. Romes, Greer, SC (US)

Correspondence Address: DORITY & MANNING, P.A., POST OFFICE BOX 1449, GREENVILLE, SC, 29602-1449, US

(73) Assignee: Guardian Building Products, Inc., Greer, SC (US)

(21) Appl. No.: 12/557,575

(22) Filed: Sep. 11, 2009

Related U.S. Application Data
(60) Provisional application No. 61/096,560, filed on Sep. 12, 2008.

(51) Int. Cl. B32B 37/00; B32B 17/02; B32B 23/02; B32B 5/02; B32B 5/00; B32B 5/18

(52) U.S. Cl. 156/293; 428/426; 428/532; 428/446; 428/220; 428/314.4; 428/319.1; 428/318.4; 428/304.4; 156/60

(57) ABSTRACT

An insulation product is comprised of a fibrous layer pre-assembled with a flexible foam layer. The layer containing the fibrous material may comprise a fiberglass layer or a layer containing cellulosic fibers. The foam layer, on the other hand, may comprise any suitable flexible foam, such as an elastomeric polyurethane foam, that creates an air barrier. The two materials are laminated together and the resulting product is delivered to a building or structure for installation.

### RELATED APPLICATIONS

The present application is based on and claims priority to U.S. Provisional Patent Ser. No. 61/096,560, filed on Sep. 12, 2008.

### BACKGROUND

Properly insulating structures such as buildings and homes continues to gain in importance especially in view of rising energy costs. One of the most common ways to insulate buildings and homes is to install batts of fiberglass or blown fiberglass insulation around the exterior walls of the structure. For example, fiberglass insulation materials are typically used to insulate attics, crawl spaces, and vertical wall cavities. Such materials have been found well suited to preventing heat from escaping from the insulated area in colder months and cool air from escaping from the area in hotter months.

Although fiberglass insulation materials have very desirable R-values in static conditions, the thermal performance of the materials significantly decreases when subjected to air flow. Thus, in the past, builders have applied a spray foam material, such as a polyurethane foam, to a surface to be insulated prior to installing fiberglass insulation. The rigid polyurethane foam has been found to serve as an effective air flow barrier while also providing other beneficial insulation characteristics.

Fiberglass and foam insulation systems, however, typically require a two-step process to install. First, for instance, the rigid polyurethane foam is applied to the surface to be insulated followed by installing fiberglass batts or loose fill. The polyurethane foam is typically formed on site by mixing a polyol with an isocyanate. Isocyanates used in the past have typically comprised aromatic isocyanates, such as diphenylmethane diisocyanate (MDI) or toluene diisocyanate (TDI). Specifically, in order to form a foam, the isocyanate component is combined with a polyol in the presence of a blowing agent and sprayed out of a nozzle onto the surface to be treated.

As can be appreciated, installing a fiberglass and foam insulation system can become very labor intensive. In particular, the process of insulating the surface requires two separate installations for the two different materials.

In addition, when producing polyurethane foams as described above, installers are typically required to wear respiratory protection in order to avoid breathing any unreacted isocyanate. For example, the United States Environmental Protection Agency indicates that short-term inhalation of high concentrations of aromatic isocyanates may cause sensitization and asthma. Further, dermal contact with aromatic isocyanates has been found to induce dermatitis and eczema in workers. Long-term inhalation exposure to isocyanates has also been shown to cause asthma, dyspnea and other respiratory impairments.

Thus, when installing polyurethane foams as described above, workers are typically required to wear a Powered Air Purifying Respirator (PAPR) or some other type of respirator that provides a filtered air supply. Further, when applying the foam using a high pressure system, typically a full body suit is recommended to be worn. The above respirators and protective garments are very expensive and very bulky and cumbersome to wear, especially in hot weather.

In view of the above, a need currently exists for a fibrous material and air barrier capable of being installed in a single step. In addition, a need also exists for a foam insulation system capable of being installed without exposing the installation workers to airborne isocyanates.

### SUMMARY

In general, the present disclosure is directed to a process and system for installing multiple layers of insulation materials on a surface. The surface, for instance, may comprise a portion of a building, a home, or other similar structure. The surface, for instance, may be part of an attic, a crawl space, a vertical wall, or the like. In accordance with the present disclosure, an air barrier, such as a flexible foam material, is laminated to a fibrous material off-site. The pre-assembled insulation layers are then cut to width and installed on a surface of a building or structure. Through the present disclosure, a fibrous insulation layer and air barrier can be installed on a surface in a single application step. In addition, the insulation product can be installed without having to wear any extensive respiratory protection systems.

For example, in one embodiment, the present disclosure is directed to an insulation product that comprises a pre-assembled laminate. In one embodiment, for instance, the insulation product can be spirally wound and can be configured to be unwound and applied to a surface for insulating the surface. Alternatively, the insulation product may be produced and sold in separate pieces that are stacked together prior to application. The separate pieces, for instance, may have a length of from about 4 feet to about 15 feet in length, with any suitable width. The insulation product includes a first layer laminated to a second layer.

The first layer, for instance, comprises a fibrous insulation material comprising a batt of fibers. The batt, for example, may comprise a fiberglass material, a cellulosic material, or stone wool fibers, such as rock wool fibers. The second layer, on the other hand, comprises an air barrier layer. The air barrier layer may be made from a flexible foam material. The foam material, for instance, may comprise a closed cell foam or an open cell foam. In one embodiment, the foam material is made from an elastomeric foam. Any suitable foam material may be used, such as a polyurethane foam.

In addition to foams, it should be understood that the air barrier layer can be made from various other flexible materials. For example, the air barrier layer can be made from any flexible material capable of inhibiting air flow. Such materials may include thermoplastic films, elastomeric films, rubber materials, and the like.

In one embodiment, the fibrous insulation material includes a first surface and an opposite second surface. The first surface may be laminated to a backing material, such as a paper or film material. The second surface of the fibrous insulation material, on the other hand, can be laminated to the air barrier layer. In one embodiment, the fibrous insulation material can be placed in direct contact with the flexible foam material.

The fibrous insulation material can be attached to the air barrier layer using any suitable technique. In one embodiment, for instance, the two layers may be mechanically attached together. Alternatively, the foam material may be formed directly on the fibrous insulation material. In this embodiment, no adhesive may be needed. In still another embodiment, an adhesive may be used in order to attach the two layers together. The adhesive may comprise any suitable adhesive, such as a hot melt adhesive.

The insulation product may have any suitable dimensions depending upon the particular application and the desired result. In one embodiment, for instance, the fibrous insulation material may have a thickness of from about 2 inches to about 12 inches. The thickness of the air barrier layer, on the other hand, can vary dramatically depending upon the type of material used to form the layer. For example, air barrier layers made from film-like materials can have thicknesses of from about 1 mil to about 250 mils, such as from about 3 mils to about 15 mils. When made from a foam material, on the other hand, the air barrier layer can have a thickness of from about 0.1 inches to about 4 inches. The insulation product can be cut so as to have a desired width. In one embodiment, for instance, the width of the product can be from about 6 inches to about 24 inches. In one embodiment, the surface to be insulated may define cavities where the insulation product is to be installed. In this embodiment, the insulation product can have a width so as to form a tension fit against opposing side walls in the cavities.

As described above, in one embodiment, the flexible foam material may comprise a polyurethane foam. The polyurethane foam may be formed, for instance, by reacting together an aromatic isocyanate with a polyol.

Other features and aspects of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of one embodiment of an insulation product made in accordance with the present disclosure;

FIG. 2 is a side view of one embodiment of a process for forming an insulation product in accordance with the present disclosure;

FIG. 3 is a side view of another embodiment of a process for forming an insulation product in accordance with the present disclosure; and

FIG. 4 is a cross-sectional view of the insulation product illustrated in FIG. 1 installed in a cavity associated with a surface that has been insulated in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present invention.

In general, the present disclosure is directed to a multi-layer insulation product for insulating the surfaces of a building or structure. The insulation product, for instance, may include a fibrous layer laminated to an air barrier, such as a foam layer. The fibrous layer has excellent insulation properties under static conditions. The foam layer, on the other hand, further improves the insulation properties of the overall material while also serving as an air barrier to prevent air from flowing through the fibrous layer. In accordance with the present disclosure, the multiple layers are pre-assembled and laminated together prior to installation.

The insulation product of the present disclosure provides various advantages and benefits. For example, the insulation product can be used to insulate a surface in a single installation step. In the past, on the other hand, similar materials were installed in a two-step process in which the foam material was first applied to a surface followed by a fibrous batt of insulation. The insulation product of the present disclosure, on the other hand, can more efficiently be installed in a single step process that dramatically reduces labor requirements.

In addition, the insulation product of the present disclosure can be installed without the installers having to wear any extensive or complicated respirators. In particular, since the foam material is formed off-site, installation of the insulation product of the present disclosure does not create any significant airborne health hazards that have been associated with on-site formed polyurethane foams in the past.

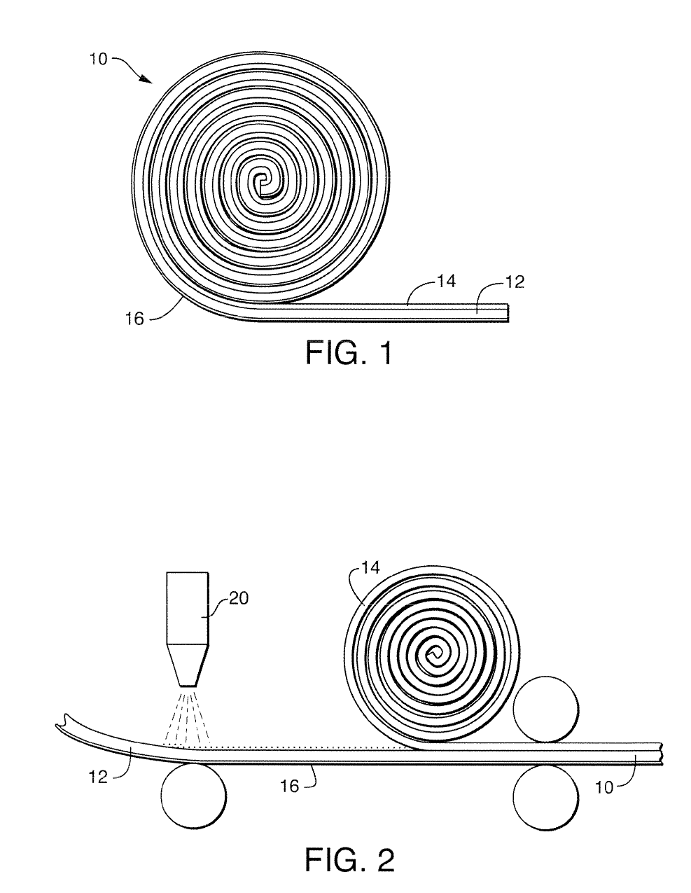

Referring to FIG. 1, for instance, one embodiment of an insulation product 10 made in accordance with the present disclosure is illustrated. As shown, in this embodiment, the insulation product 10 comprises a spirally wound product. Specifically, after the material is produced, the material is wound into rolls for convenient delivery to the location where the product is to be installed. In order to install the product, the roll is unwound and cut to length.

Alternatively, the insulation product 10 can be cut to a desired length and then stacked prior to shipping to the location where the product is to be installed. In this embodiment, the insulation product can be cut into squares, rectangles, or in any other suitable shape. In one embodiment, for instance, the insulation product may be cut into strips having a length of from about 2 feet to about 20 feet, such as from about 5 feet to about 12 feet.

The insulation product 10 as shown in FIG. 1 generally includes a first layer of insulation material 12 laminated to a second layer of insulation material 14. In one embodiment, the first layer 12 comprises a fibrous insulation material. For instance, the first layer 12 may comprise a batt of fiberglass insulation. Alternatively, the first layer 12 may comprise a batt of cellulosic fibers, stone wool fibers or mixtures thereof.

In one embodiment, the first layer 12 of fibrous insulation material may optionally include a backing layer 16. The backing layer can be included to provide integrity to the product and to assist in manipulating the product during insulation. The backing layer 16, for instance, may comprise a paper material, a polymer film, or a combination thereof.

The second layer of material 14 generally comprises an air barrier layer that prevents air from circulating through the first layer of material 12 and reducing the insulating properties of the first layer. The second layer of material 14 can also have insulation properties as well.

In one embodiment, the second layer of material 14 is made from a flexible foam material, such as an elastomeric foam. Foam materials that may be used include, for instance, polyurethane foams, polyether foams, silicone foams, polyester foams, vinyl/polyvinylchloride foams, natural rubber foams, and the like. The foam material can have an open cell structure although, in one embodiment, the foam desirably has a closed cell structure.

In addition to foams, any suitable air barrier material may be used. For instance, in other embodiments, the second layer of material 14 may comprise a film. The film can be made from a thermoplastic polymer, an elastomeric polymer, and/or a rubber material. The film, for instance, can have a thickness from about 3 mm to about 5 cm.

When the air barrier comprises a foam material, the dimensions and properties of the fibrous material layer 12 and the foam layer 14 can vary dramatically depending upon the particular application and the desired result. For exemplary purposes only, in one embodiment, the fibrous material layer 12 may have a thickness of from about 2 inches to about 12 inches, such as from about 4 inches to about 10 inches. The second layer 14, on the other hand, may have a thickness of generally from about 0.25 inches to about 2 inches, such as from about 0.5 inches to about 1 inch.

Insulation products are typically rated in the building industry by an R-value.

The higher the R-value, the greater the insulation properties. The R-value of a material is a measure of apparent thermoconductivity and thus describes the rate that heat energy is transferred through a material or assembly. The insulation product 10 as shown in FIG. 1 can generally have any desirable R-value depending upon the thickness of the materials. Fibrous materials, such as fiberglass, for instance, typically have an R-value of from about 3.5 to about 4 per inch. In this regard, the first layer 12, for instance, made from the fibrous material can have an R-value of from about R-10 to about R-40.

The second layer of material 14, on the other hand, can have a relatively low R-value or a relatively high R-value depending upon the material used. Foam materials, for instance, can have an R-value of from about 3 to about 6 per inch depending upon whether the foam is open cell or closed cell. Thus, the second layer of material 14, depending upon the thickness of the material, can have an R-value of from about R-2 to about R-40, such as from about R-3 to about R-20.

The overall R-value of the insulation product 10 can generally range from about R-12 to about R-50, or even higher depending upon the particular application.

In general, the first layer 12 can be laminated to the second layer 14 using any suitable technique. The layers can be laminated together in one embodiment using an adhesive. Alternatively, an adhesive may not be necessary. In another embodiment, the first layer 12 may be attached to the second layer 14 using a mechanical attachment structure.

As shown in FIG. 2, in one embodiment, an air barrier such as a preformed layer of foam material 14 can be laminated to a fibrous layer 12 by applying an adhesive in between the two layers are they are moving down a processing line. For example, as shown in FIG. 2, a nozzle 20 is shown to apply the adhesive material.

In general, any suitable adhesive may be used. For instance, in one embodiment, the two materials may be laminated together using a hot melt adhesive. Suitable hot melt adhesives include polyolefin adhesives such as those based on polypropylene or polyethylene, adhesives containing ethylene vinyl acetate copolymers, adhesives containing styrene-isoprene-styrene copolymers, adhesives containing styrene-butadiene-styrene copolymers, adhesives containing ethylene ethyl acrylate copolymers and adhesives containing polyurethane reactives.

The adhesive material can be applied to the first layer 12 and then laminated to the second layer 14, may be applied to the second layer 14 and then laminated to the first layer 12, or may be applied to both layers as they are laminated together. In the embodiment illustrated in FIG. 2, the adhesive material is sprayed onto the materials. In other embodiments, however, the adhesive material may be printed on one of the layers, extruded onto one of the layers, or applied using any other suitable technique. The adhesive may be applied so as to uniformly cover a surface of one of the materials, may be applied as discrete islands on one of the materials or can be applied in a reticulated pattern.

Once the adhesive material is applied in between the layers, the layers may be compressed in order to ensure proper bonding. In other embodiments, however, compression may not be needed.

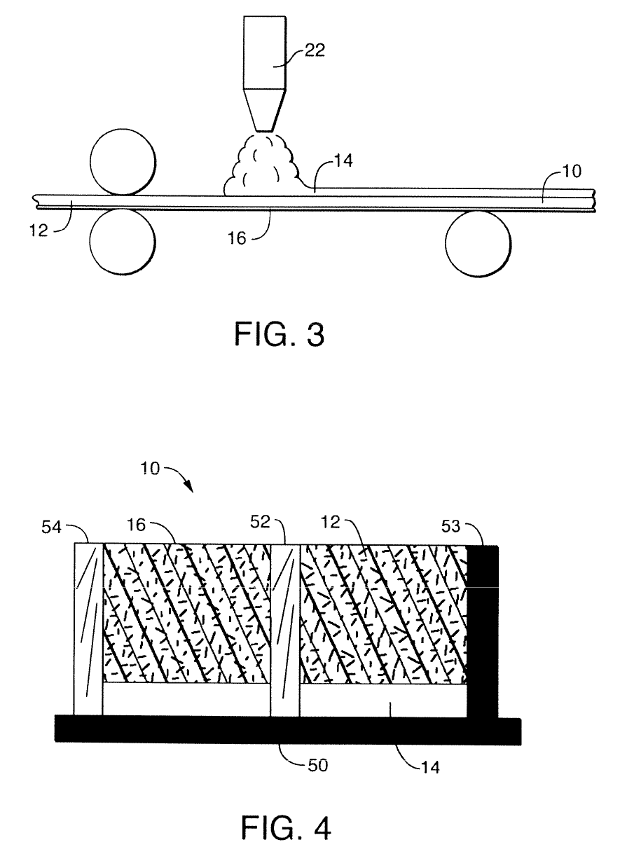

Referring to FIG. 3, another embodiment of a method for forming the insulation product of the present disclosure is illustrated. In this embodiment, the air barrier such as a foam layer 14 is formed directly on the fibrous material layer 12. In particular, the materials used to form the foam material 14 are sprayed through a nozzle 22 directly onto the fibrous layer 12. Of particular advantage, many foam materials have inherent adhesive properties during formation. Thus, in this embodiment, the use of an adhesive may not be necessary since the foam material may form a bond with the fibrous layer 12 during production of the foam.

In one embodiment, the foam material 14 formed directly on the fibrous layer 12 may comprise a polyurethane foam formed from two components. For example, the nozzle 22 may be placed in communication with a first pressurized container containing a first component typically referred to as the “A” component and a second pressurized container containing a second component typically referred to as the “B” component. The two components are combined in the nozzle 22 and formed into a foam which, as shown, is directly applied to the surface of the fibrous layer 12.

When the two components are combined in the nozzle 22, an exothermic reaction takes place as the resulting material is emitted from the nozzle. Small bubbles form during the reaction which become trapped in the newly formed material. As the foam is applied to the surface of the fibrous layer 12, the foam hardens. In one embodiment, the foam may expand as it solidifies. The amount of expansion can be controlled depending upon the particular reactants being used.

The polyurethane foam 14 contained in the insulation product is flexible and, for instance, may comprise an elastomeric foam. In order to form the polyurethane foam, the A component generally contains an isocyanate, while the B component contains a polyol. The isocyanate used in the A component can vary depending upon the particular application. In one embodiment, the isocyanate is an aromatic isocyanate. Examples of aromatic isocyanates, include, for instance, diphenylmethane diisocyanate (MDI), toluene diisocyanate (TDI), mixtures thereof, or any of their oligomers, pre-polymers, dimmers, trimers, allophanates, or uretidiones.

Other isocyanates that may be used include hexamethylene diisocyanate (HMDI), HDI, IPDI, TMXDI (1,3-bis-isocyanato-1-methylene ethylene benzene), or any of their oligomers, pre-polymers, dimmers, trimers, allophanates and uretidiones.

Suitable polyisocyanates include, but are not limited to, toluene-2,4-diisocyanate, toluene-2,6-diisocyanate, (this is TDI 80/20 from above) commercial mixtures of toluene-2,4- and 2,6-diisocyanates, ethylene diisocyanate, ethylidene diisocyanate, propylene-1,2-diisocyanate, cyclohexylene-1,2-diisocyanate, cyclohexylene-1,4-diisocyanate, m-phenylene diisocyanate, 3,3′-diphenyl-4,4′-biphenylene diisocyanate, 4,4′-biphenylene diisocyanate, 3,3′-dichloro-4,4′-biphenylene diisocyanate, 1,6-hexamethylene diisocyanate, 1,4-tetramethylene diisocyanate, 1,10-decamethylene diisocyanate, 1,5-naphthalenediisocyanate, cumene-2,4-diisocyanate, 4-methoxy-1,3-phenylenediisocyanate, 4-chloro-1,3-phenylenediisocyanate, 4-bromo-1,3-phenylenediisocyanate, 4-ethoxy-1,3-phenylenediisocyanate, 2,4′-diisocyanatodiphenylether, 5,6-dimethyl-1,3-phenylenediisocyanate, 2,4-dimethyl-1,3-phenylenediisocyanate, 4,4′-diisocyanatodiphenylether, benzidinediisocyanate, 4,6-dimethyl-1,3-phenylenediisocyanate, 9,10-anthracenediisocyanate, 4,4′-diisocyanatodibenzyl, 3,3′-dimethyl-4,4′-diisocyanatodiphenylmethane, 2,6-dimethyl-4,4-diisocyanatodiphenyl, 2,4-diisocyanatostilbene, 3,3′-dimethyl-4,4′-diisocyanatodiphenyl, 3,3′-dimethoxy-4,4′-diisocyanatodiphenyl, 4,4′-methylene bis(diphenylisocyanate), 4,4′-methylene is(dicyclohexylisocyanate), isophorone diisocyanate, PAPI (a polymeric diphenylmethane diisocyanate, or polyaryl polyisocyanate), 1,4-anthracenediisocyanate, 2,5-fluorenediisocyanate, 1,8-aphthalenediisocyanate and 2,6-diisocyanatobenzfuran.

Also suitable are aliphatic polyisocyanates such as the triisocyanate Desmodur N-100 sold by Mobay (Mobay no longer exists, a BAYER company now) which is a biuret adduct of hexamethylenediisocyanate; the diisocyanate Hylene W sold by du Pont, which is 4,4′-dicyclohexylmethane diisocyanate; the diisocyanate IPDI or Isophorone Diisocyanate sold by Thorson Chemical Corp., 25 which is 3-isocyanatomethyl-3,5,5-trimethylcyclohexyl isocyanate; or the diisocyanate THMDI sold by Verba-Chemie, which is a mixture of 2,2,4- and 2,4,4-isomers of trimethyl hexamethylene diisocyanate.

Further examples of suitable isocyanate components include 2,4-tolylenediisocyanate, 2,6-tolylenediisocyanate, 4,4′-diphenylmethanediisocyanate, 4,4′-diphenylthere-diisocyanate, m-phenylenediisocyanate, 1,5-naphthalene-diisocyanate, biphenylenediisocyanate, 3,3′-dimethyl-4,4′ biphenylenediisocyanate, dicyclohexylmethane-4,4′ diisocyanate, p-xylylenediisocyanate, bis(4-isocyanatophynyl) sulfone, isopropylidene bis(4-phenylisocyanate), tetramethylene diisocyanate, isophorone diisocyanate, ethylene diisocyanate, trimethylene, propylene-1,2-diisocyanate, ethylidene diisocyanate, cyclopentylene-1,3-diisocyanates, 1,2-,1,3- or 1,4 cyclohexylene diisocyanates, 1,3- or 1,4-phenylene diisocyanates, polymethylene ployphenylleisocyanates, bis(4-isocyanatophenyl)methane, 4,4′-diphenylpropane diisocyanates, bis(2-isocyanatoethyl) carbonate, 1-methyl-2,4-diisocyanatocycloheane, chlorophenylene diisocyanates, triphenylmethane-4,4′4″-triisocyanate, isopropyl benzene-a-4-diisocyanate, 5,6-diisocnanatobutylbicyclo [2.2.1]hept-2ene, hexahydrotolylene diisocyanate, 1-methoxyphenyl-2,4-diisocyanate, 4,4′4″-triphenylmethane triisocyanate, polymethylene polyohenylisocyanate, tolylene-2,4,6-triisocyanate, 4,4′-dimethyldiphenylmethane-2,2′5,5′-tetraisocyanate, and mixtures thereof.

As described above, the B component combined with the isocyanate generally contains a polyol. As used herein, the term “polyol” refers to a molecule that contains more than one hydroxyl group. The particular polyol chosen may depend upon various factors and the amount of flexibility required in the resulting product. In one embodiment, a mixture of polyols may be used.

Examples of polyols that can be used in the B component include polyether polyols including diols and triols, polyester polyols, polycarbonate polyols, polyacetal polyols, polyolefin polyols, caprolactone-based polyols, and the like.

In one embodiment, for instance, a polyoxypropylene polyol, a polyoxyethylene polyol or a poly(oxyethylene-oxypropylene) polyol may be used. For example, one commercially available polyether triol that may be included in the B component is sold under the trade name XD 1421, which is made by the Dow Chemical Company. It has a molecular weight of around 4900, and is composed of a ratio of three oxyethylene units randomly copolymerized per one unit of oxypropylene. This is commonly called ethylene oxide above and propylene oxide for the later. It has a hydroxy content of 0.61 meq. OH/g. Another example of a material which is commercially available is Pluracol® V-7 made by BASF Wyandotte which is a high molecular weight liquid polyoxyalkylene polyol. Other polyols which might be used at polyether polyols such as Pluracol 492 from BASF, having a molecular weight of 2000.

Polyester polyols that may be used are generally prepared from the condensation of a saturated or unsaturated mono- or poly-carboxylic acid and a polyhydric alcohol. Examples of suitable polyhydric alcohols include the following: glycerol; pentaerythritol; mannitol; trimethylolpropane; sorbitol; methyltrimethylolmethane; 1,4,6-octanetriol; ethylene glycol, diethylene glycol, propylene glycol butanediol; pentanediol; hexanediol; dodecanediol; octanediol; chloropentanediol, glycerol monoallyl ether glycerol; monoethyl ether; triethylene glycol; 2-ethyl hexanediol-1,4; 3,3′-thiodipropanol; 4,4′-sulfonyldihexanol; cyclohexanediol-1,4; 1,2,6-hexanetriol, 1,3,5 hexanetriol; polyallyl alcohol; 1,3-bis (2-hydroxyethoxy) propane; 5,5′-dihydroxydiamyl ether; 2,5-dipropanol tetrahydrofuran-2,5-dipentanol, 2,5-dihydroxytetrahydro furan; tetrahydropyrrole-2,5 propanol; 3,4-dihydroxy tetrahydropyran; 2,5-dihydroxy-3,4-dihydro-1,2 pyran; 4,4′-sulfinyldipropanol; 2,2-bis(4-hydroxyphenyl)-propane; 2,2′-bis(4-hydroxyphenyl)methane, and the like.

Examples of polycarboxylic acids include the following: phthalic acid, isophthalic acid; tetrachlorophthali acid; maleic acid; dodecylmaleic acid; octadecenylmalei acid; fumaric acid; aconitic acid, itaconic acid, trimellitic acid; tricarballylic acid; 3,3′-thiodipropionic acid; 4,4′-sulfonyl-dihexanoic acid; 3-octenedioic-1,7 acid; 3-methyl-3decenedioic acid; succinic acid; adipic acid; 1,4-cyclohexadiene-1,2-dicarboxylic acid; 3-methyl-3,5-cyclohexadiene 1,2-dicarboxylic acid; 8,12-eicosadienedioic acid; 8-vinyl 10-octadecenedioic acid; and the corresponding acid anhydrides, acid chlorides, and acid esters such as phthalic anhydride, phthaloyl chloride, and the dimethyl ester of phthalic acid. Other polyols may be used herein such as specialty types that are not considered as being purely polyester polyol.

Particular polyester polyols which may be used include hydroxyl-terminated reaction products of dihydric alcohols such as ethylene glycol, propylene glycol, diethylene glycol, 1,4-butanediol, neopentyl glycol, 1,6-hexanediol or cyclohexane dimethanol or mixtures of such dihydric alcohols, and dicarboxylic acids or their ester-forming derivatives, for example succinic, glutaric and adipic acids or their dimethyl esters, sebacic acid, phthalic anhydride, tetrachlorophthalic anhydride or dimethyl terephthalate or mixtures thereof.

Polyesteramides may be obtained by the inclusion of aminoalcohols such as ethanolamine in polyesterification mixtures.

Polythioether polyols which may be used include products obtained by condensing thiodiglycol either alone or with other glycols, alkylene oxides, dicarboxylic acids, formaldehyde, amino-alcohols or aminocarboxylic acids.

Polycarbonate polyols which may be used include products obtained by reacting diols such as 1,3-propanediol, 1,4-butanediol, 1,6-hexanediol diethylene glycol or tetraethylene glycol with diaryl carbonates, for example diphenyl carbonate, or with phosgene.

Polyacetal polyols which may be used include those prepared by reacting glycols such as diethylene glycol, triethylene glycol or hexanediol with formaldehyde. Suitable polyacetals may also be prepared by polymerising cyclic acetals.

Suitable polyolefin polyols include hydroxy-terminated butadiene homo- and copolymers and suitable polysiloxane polyols include polydimethylsiloxane diols.

In one embodiment, a polyol chain extender may be included in component B. The chain extender may be used to increase the length of the carbon chains in the polyurethane foam compositions. Suitable chain extenders include aliphatic diols, such as ethylene glycol, 1,3-propanediol, 2-methyl-1,3-propanediol, 1,4-butanediol, 1,5-pentanediol, 1,6-hexanediol, 1,2-propanediol, 1,3-butanediol, 2,3-butanediol, 1,3-pentanediol, 1,2-hexanediol, 3-methylpentane-1,5-diol, 2,2-dimethyl-1,3-propanediol, diethylene glycol, dipropylene glycol and tripropylene glycol, and aminoalcohols such as ethanolamine, N-methyldiethanolamine, N-ethyldiethanolamine and the like. Other chain extenders that may be used include hydroquinone di(ethyl ether) or primary diamines such as ethylene diamine, hydrazine, 3,5-diethyl toluene diamine, or methylene bis-orthochloraniline.

The polyol used in component B may have any suitable molecular weight. For instance, the molecular weight of the polyol may be greater than about 1000, such as from about 2000 to about 10,000. The polyol may also have a hydroxyl number of greater than about 300, such as greater than about 1000. For instance, the polyol may have a hydroxyl number of from about 300 to about 3000.

In addition to a polyol, the B component may also contain a catalyst. The catalyst may comprise, for instance, an amine compound or an organometallic complex. Amine catalysts that may be used include triethylenediamine, dimethylcyclohexylamine, dimethylethanolamine, tetramethylbutanediamine, bis-(2-dimethylaminoethyl)ether, triethylamine, pentamethyldiethylenetriamine, benzyldimethylamine, and the like.

Organometallic catalysts that may be used include compounds based on mercury, lead, tin, bismuth, or zinc. Particular examples of organometallic catalysts are alkyltincarboxylates, oxides and mercaptides oxides.

It should be understood, however, that in some applications a catalyst may not be needed.

In addition to a catalyst, the B component may also contain a plasticizer. In one embodiment, for instance, a phthalate plasticizer may be used. Examples of plasticizers include alkyl aryl phthalates, or alkyl benzyl phthalates, including butyl benzyl phthalate, alkyl benzyl phthalate wherein the alkyl group has a carbon chain of from seven to nine carbon atoms. Texanol benzyl phthalate, alkyl phenyl phthalate, symmetrical and unsymmetrical dialkyl phthalates including diisononyl phthalate, diisodecyl phthalate, dioctyl phthalate, dihexyl phthalate, diheptyl phthalate, butyloctyl phthalate, linear dialkyl phthalate wherein the alkyl groups are independently carbon chains having from seven to eleven carbon atoms, and butyl cyclohexyl phthalate; and phosphate ester plasticizers such as, for example, 2-ethylhexyl diphenyl phosphate, isodecyl diphenyl phosphate, mixed dodecyl and tetradecyl diphenyl phosphate, trioctyl phosphate, tributyl phosphate, butylphenyl diphenyl phosphate and isopropylated triphenyl phosphate; and benzoate plasticizers such as, for example, Texanol benzoate, glycol benzoate, propylene glycol dibenzoate, dipropylene glycol dibenzoate and propylene glycol dibenzoate.

To form the polyurethane foam, the two components may be sprayed through the nozzle 22 under pressure. In one embodiment, the pressure may be relatively low, such as less than about 200 psi. In other embodiments, however, a higher pressure may be desirable. For instance, the components may be under a pressure of greater than about 200 psi, such as from about 300 psi to about 1400 psi.

To form the foam material, in one embodiment, a blowing agent may be desired. In one embodiment, for instance, the blowing agent may comprise water. In addition to water, other blowing agents that may be used include chlorofluorocarbons, hydrofluorocarbons, or hydrochlorofluorocarbons. Still other blowing agents that may be used include carbon dioxide, pentane or various hydrocarbons.

The amount of blowing agent used in any particular application depends upon the reactants, the pressure at which the components are mixed, and various other factors. In general, for instance, the blowing agent may be present in an amount greater than zero to greater than about 20 parts by weight. The particular blowing agent used in the process and the amount of blowing agent may also have an impact upon the cell structure of the resulting foam. For instance, use of a particular blowing agent may result in an open cell structure or a closed cell structure.

The resulting foam can have any suitable density depending upon the particular application. The density of the foam, for instance, can be at least about 0.5 lb/ft³. In one embodiment, for instance, the density can be from about 1.5 lbs/ft³ to about 2.5 lbs/ft³, such as from about 1.75 lbs/ft³ to about 2 lbs/ft³. The resulting foam can be compressible and/or flexible. The foam can also have elastic properties. For instance, the foam can have an elongation of over 125 percent, such as over 150 percent, such as over 175 percent. For example, in one embodiment, the foam can have an elongation of from about 150 percent to about 300 percent.

Once the insulation product 10 is formed as shown in either FIG. 2 or 3, the laminated product is either wound into rolls as shown in FIG. 1 or cut and stacked into strips. The insulation product is then delivered and installed against a surface of a structure or building. The insulation material can be cut to any desired width. For instance, the width of the product can be generally from about 6 inches to about 4 feet, such as from about 6 inches to about 2 feet.

Referring to FIG. 4, for exemplary purposes only, a surface 50 insulated in accordance with the present disclosure is shown. More particularly, FIG. 1 is intended to illustrate a cross-sectional view of an insulated wall cavity such as a ceiling or attic. It should be understood, however, that laminated products made according to the present disclosure can be used to insulate various other areas of a structure or building as well. In this embodiment, the surface 50 comprises a ceiling that is attached to studs 52, 53, and 54. In between each pair of studs is the insulation product 10 made in accordance with the present disclosure. The insulation product 10 is applied to the surface 50 in order to insulate the ceiling and particularly prevent airflow through the cavity.

As shown, in this embodiment, the insulation product 10 comprises an air barrier such as a foam layer 14 laminated to a fibrous layer 12. When the foam material 14 is combined with the fibrous layer 12, the foam material can serve as an air barrier for preventing or reducing air flow from reaching the batt of insulation. Air flow through the batt of insulation may have detrimental effects on the ability of the fibrous material to insulate the surface. Thus, the foam material 14 can block or substantially block air flow through the cavity and thereby maintain or even improve the R-value of the product.

In the embodiment illustrated, the foam layer 14 is positioned directly adjacent to the surface 50. In an alternative embodiment, the insulation product 10 may include two different foam layers. The fibrous material 12, for instance, may be positioned in between two layers of foam material.

In one embodiment, the width of the insulation product 10 may be such that the insulation product forms a friction fit in between the studs of the cavity. Of particular advantage, since the foam material 14 is flexible, the foam material will conform to the contours of the surface and fill any cracks or crevices present.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A spirally wound insulation product configured to be unwound and applied to a surface for insulating the surface comprising a first layer laminated to a second layer, the first layer comprising a fibrous insulation material comprising a batt of fibers, the second layer comprising an air barrier layer.

2. A spirally wound insulation product as defined in claim 1, wherein the fibrous insulation material contains glass fibers.

3. A spirally wound insulation product as defined in claim 1, wherein the fibrous insulation material contains cellulosic fibers or stone wool fibers.

4. A spirally wound insulation product as defined in claim 2, wherein the first layer has a first surface and a second surface, the first surface being laminated to a backing material, the second surface being laminated to the air barrier layer, the fibrous insulation material being in direct contact with the air barrier layer.

5. A spirally wound insulation product as defined in claim 1, wherein the product has a width of at least about eight inches.

6. A spirally wound insulation product as defined in claim 1, further comprising an adhesive attaching the first layer to the second layer.

7. A spirally wound insulation product as defined in claim 1, wherein the first layer is laminated to the second layer without using an adhesive.

8. A spirally wound insulation product as defined in claim 1, wherein the air barrier layer comprises a flexible foam material comprising a closed cell foam.

9. A spirally wound insulation product as defined in claim 1, wherein the air barrier layer comprises a flexible foam material comprising an open cell foam.

10. A spirally wound insulation product as defined in claim 1, wherein the air barrier layer comprises a flexible foam material comprising a polyurethane foam.

11. A spirally wound insulation product as defined in claim 10, wherein the first layer has a thickness of from about two inches to about 12 inches and wherein the second layer has a thickness of from about 0.1 inches to about 2 inches.

12. A spirally wound insulation product as defined in claim 1, wherein the air barrier layer comprises an elastomeric foam.

13. A spirally wound insulation product as defined in claim 1, wherein the second layer is formed in-situ on the first layer by spraying a foam-making composition onto the first layer.

14. A spirally wound insulation product as defined in claim 10, wherein the foam material is formed by reacting an aromatic isocyanate with a polyol.

15. A method of insulating a surface comprising unwinding the insulation product defined in claim 1 onto the surface.

16. A method as defined in claim 15, wherein the surface defines cavities having opposing side walls and wherein the insulation product is installed in the cavities so as to form a tension fit against the opposing side walls of the cavities.

17. An insulation product for later applying to a surface in order to insulate the surface comprising a first layer laminated to a second layer, the first layer comprising a fibrous insulation material comprising a batt of fibers, the first layer having a first surface and a second surface, the first surface being laminated to a backing material, the second layer laminated to the first layer comprising an air barrier layer comprising a flexible foam material, the foam material being laminated to the second surface of the first layer, the foam material being in direct contact with the fibrous insulation material, the foam material comprising a polyurethane foam, and wherein the first layer has a thickness of from about 2 inches to about 12 inches and the second layer has a thickness of from about 0.25 inches to about 2 inches.

18. An insulation product as defined in claim 17, wherein the foam material comprises an open cell foam.

19. An insulation product as defined in claim 17, wherein the foam material comprises a closed cell foam.

20. An insulation product as defined in claim 17, wherein the foam material comprises an elastomeric foam.

21. An insulation product as defined in claim 17, wherein the first layer is laminated to the second layer without using an adhesive.
